(19) United States
(12) Patent Application Publication
(10) Pub. No.: US 2013/0037046 A1
(43) Pub. Date: Feb. 14, 2013

(54) FLEXIBLE FLAT TOOTHPICK

(71) Applicant: Paola Viridiana Loera Pulido, Nuevo Leon (MX)

(72) Inventor: Paola Viridiana Loera Pulido, Nuevo Leon (MX)

(21) Appl. No.: 13/643,481

(22) PCT Filed: Jun. 9, 2011
(86) PCT No.: PCT/MX11/00072

§ 371 Date: Oct. 25, 2012

(30) Foreign Application Priority Data
Aug. 31, 2010 (MX) MX/U/2010/000362

(51) Int. Cl. A61C 15/02

(52) U.S. Cl. 132/329

(57) ABSTRACT

A toothpick made of a flexible flat material, which is non-toxic, not brittle, and will not splinter, which takes the form of a substantially rectangular, elongate strip of said material which is pointed at each end, the points forming the tips of the toothpick. Said ends may be triangular, trapezoidal or hook-shaped. Furthermore, at the centre, the toothpick has a non-slip surface so that the user can get a better grip.

### BRIEF SUMMARY OF THE INVENTION

The present invention refers to a toothpick made from a flexible material, being flat to allow for the cleaning of the teeth, reaching a deeper penetration within the gap between the teeth, while avoiding injury of the gums and without any risk of the toothpick getting splintered or broken. Furthermore, due to the fact that said toothpick is a flat strip, it avoids causing additional diastema when it is introduced in between the teeth.

### BACKGROUND OF THE INVENTION

There are toothpicks in the market, formed with a stick made out of different materials shaped with a circular or rectangular cross section, sharpen at one or both ends. Some models are coated with chlorophyll or other pigments to scent the mouth during its use. Most toothpicks are made out of wood, which is easily broken or chipped, leaving splinters in between the teeth, causing injury to the gums. Other toothpicks are made out of plastic materials, which are stiff and brittle, damaging the gums. These toothpicks cannot penetrate adequately between the teeth, due to their conic shaped tip when cylindrical and wedge tip when rectangular. Their reach is limited to the length of their tip, becoming ineffective as the gap between the teeth is reduced. If one of theses toothpicks is introduced between the teeth with excessive force, it could cause diastema, due to the toothpick's thickness. Another problem is the difficulty of using them discreetly, due to their stiffness, shape and size, which leads the user to make hideous movements with the mouth and hand to position the toothpick in the right place to reach food particles stuck between the teeth.

### BRIEF DESCRIPTION OF THE DRAWINGS

FIG. 1 shows a flexible flat toothpick with one trapezoidal end.

FIG. 2 shows a flexible flat toothpick with two trapezoidal ends.

FIG. 3 shows a flexible flat toothpick with a triangular end.

FIG. 4 shows a flexible flat toothpick with one end in the shape of a hook.

FIG. 5 shows a flexible flat toothpick with anti slip coat for handling

### DETAILED DESCRIPTION OF THE INVENTION

An embodiment of the present invention is a toothpick (1) consisting of a thin strip substantially rectangular, preferably made out of flexible plastic or other flexible material. Besides being flexible, the material must be non-toxic, not brittle nor prone to splinter. Said toothpick is formed from one elongated piece of length comprised between 4.5 cm and 5.5 cm, being preferably of exactly 5 cm long, since this length fits the dimensions of an average person's mouth. The width of the strip conforming the toothpick is comprised between 1 mm to 5 mm, being preferably of exactly 3 mm, to allow the user to hold said toothpick with the thumb and index fingers. The thickness of said strip is comprised between 0.254 mm and 0.381 mm. Said width and thickness allows said toothpick to have some stiffness or resistance to flexion. Both ends of said strip have a vertex (5). Each one of said vertices (5) on both ends of said strip is sharpened, forming the tips (2) of the toothpick (1), wherein said tips are introduced in the gap between the teeth to remove food particles. Said tips (2) of the toothpick (1) are smooth to avoid injury of the gums in the case of an accidental contact with them. The radius of the curvature of said tips (2) is comprised between 0.4 mm and 1 mm, being preferably of exactly 0.6 mm.

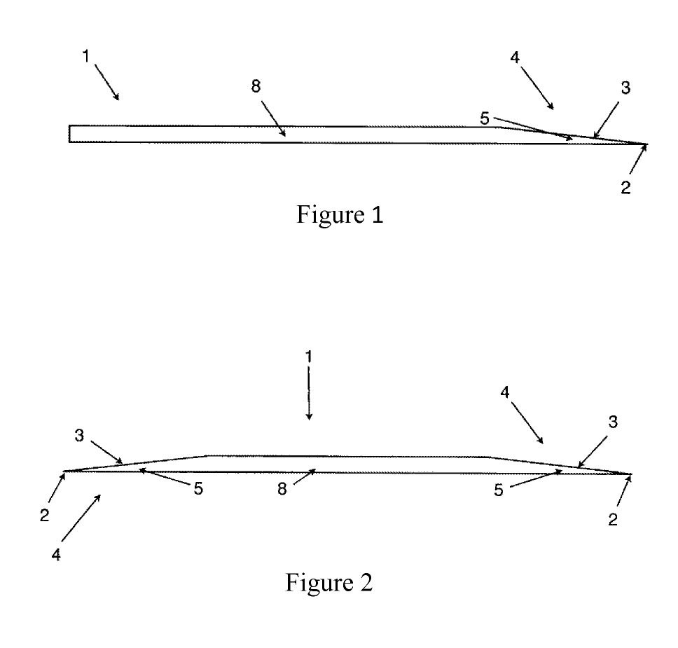

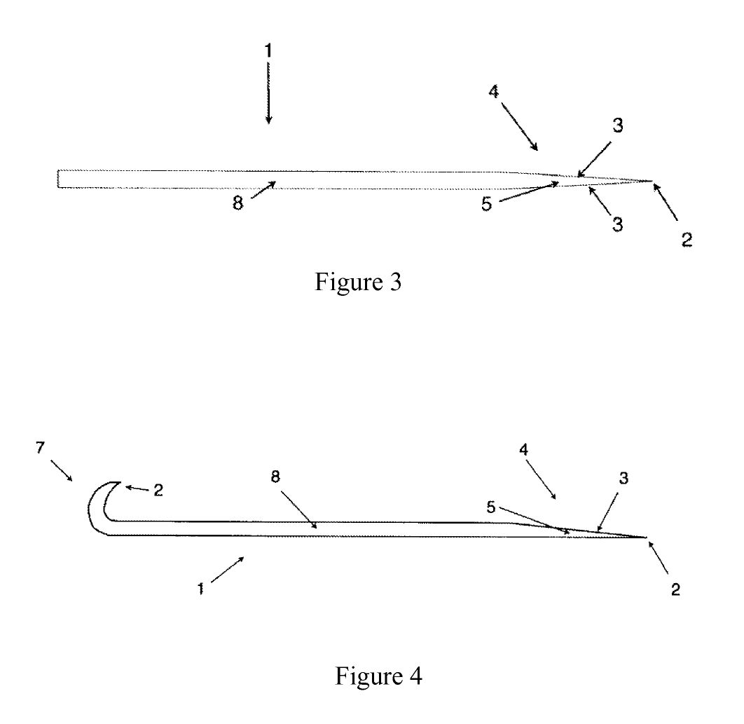

Said vertices on the ends of said strip are formed from diagonal cuts (3) on the corners of the rectangular strip. Each diagonal cut (3) is made starting from one corner of said strip and ending on the longer side of the rectangle conforming the strip, said longer side being opposite to the longer side conforming the corner of said strip where said cut is started, thus, forming a trapezoidal end (4), wherein the angle of vertex (5) is comprised between 10° and 15°, preferably being of exactly 12.5°. The above can be seen in FIGS. 1 and 2. Another embodiment of the toothpick (1) consists of two diagonal cuts (3) on the two contiguous corners at each end of the strip, said corners adjoined by one short side of the rectangle conforming said strip, so that said diagonal cuts (3) meet with each other shaping the vertex (5), forming the tip (2) of the toothpick (1), making a triangular end (6). This embodiment can be seen in FIG. 3.

Yet another embodiment of the toothpick (1) consists of one end having the shape of a hook (7) extended towards one side of the toothpick (1), with a curvature comprised between 90° and 180°, being preferably of exactly 150°, allowing the user to position the hook (7) in the gap between the teeth and pull in the opposite direction. This embodiment can be seen in FIG. 4.

The toothpick (1) may have a tip (2) in one or both ends and said ends may be either both triangular (6), both trapezoidal (4) or one end trapezoidal (4) and one end triangular (6). Furthermore, one of the tips (2) of said toothpick (1) may be replaced by a hook (7) shaped end.

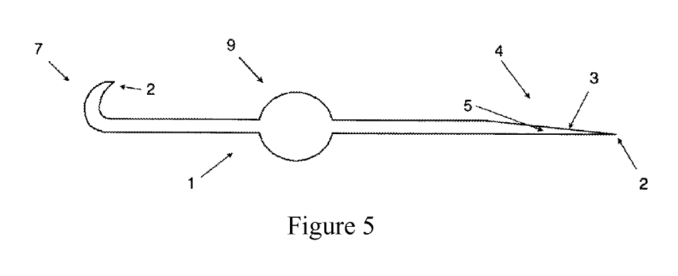

One additional characteristic of the toothpick (1) is that it may be covered with a non-slip coating over its central portion (8), on both sides so the user can achieve a better holding grip. Another option is that the toothpick (1) may have a circular plastic piece (9) of non-slip material, of 1.5 cm in diameter, attached to its central portion (8) to achieve a more comfortable grip by the user when holding the toothpick (1), as can be seen in FIG. 5. The combination of characteristics described above form a toothpick (1) having a set of advantages, including that it does not break or splinter, it does not separate teeth, it is ergonomic and it penetrates with added ease into the gap between teeth. Another advantage of the present invention is that it can be used to remove particles of food stuck in orthodontic brackets, due to its ease to bend to reach the spots between the brackets and the teeth to remove the particles of food, without pushing or forcing the brackets, because of its hook (7) and its flexibility.

1-9. (canceled)

10. Toothpick comprising a thin flexible flat elongated strip being substantially rectangular made from a non-toxic, not brittle and not splintery material with a length comprised between 4.5 cm and 5.5 cm, with a width comprised between 1 mm and 5 mm, with a thickness comprised between 0.254 mm and 0.381 mm; wherein said strip is coated with anti-slip material in the central portion, on both sides; wherein the ends of said strip have a sharpened vertex, forming the tips of the toothpick, wherein said tips are smooth with a curvature radius comprised between 0.4 mm and 1 mm; wherein said sharpened vertices at the ends of said strip are formed from diagonal cuts on the corners of said rectangular strip, each diagonal cut being made starting from one corner of said strip and ending on the longer side of the rectangle conforming the strip, said longer side being opposite to the longer side conforming the corner of said strip where said cut is started, thus, forming a trapezoidal end, wherein the angle of vertex is comprised between 10° and 15°.

11. Toothpick comprising a thin flexible flat elongated strip being substantially rectangular made from a non-toxic, not brittle and not splintery material with a length comprised between 4.5 cm and 5.5 cm, with a width comprised between 1 mm and 5 mm, with a thickness comprised between 0.254 mm and 0.381 mm; wherein said strip is coated with anti-slip material in the central portion, on both sides; wherein the ends of said strip have a sharpened vertex, forming the tips of the toothpick, wherein said tips are smooth with a curvature radius comprised between 0.4 mm and 1 mm; wherein said vertices on both ends of said strip are formed from two diagonal cuts on two contiguous corners of said strip, said corners adjoined by one short side of the rectangle conforming said strip, so that said diagonal cuts meet with each other shaping the vertex, forming the tip of the toothpick, making a triangular end.

12. Toothpick comprising a thin flexible flat elongated strip being substantially rectangular made from a non-toxic, not brittle and not splintery material with a length comprised between 4.5 cm and 5.5 cm, with a width comprised between 1 mm and 5 mm, with a thickness comprised between 0.254 mm and 0.381 mm; wherein said strip is coated with anti-slip material in the central portion, on both sides; wherein the ends of said strip have a sharpened vertex, forming the tips of the toothpick, wherein said tips are smooth with a curvature radius comprised between 0.4 mm and 1 mm; wherein the end of the toothpick consists of a hook extended towards one side of said toothpick, with a curvature comprised between 90° and 180°.

13. Toothpick as defined by claim 10, comprising a circular anti-slip plastic piece of 1.5 cm in diameter, in the central portion of said toothpick.

14. Toothpick as defined by claim 10, comprising a tip on one or both ends.

15. Toothpick as defined by claim 14, comprising a triangular tip on each end of said toothpick.

16. Toothpick as defined by claim 14, comprising a trapezoidal tip on each end of said toothpick.

17. Toothpick as defined by claim 14, comprising a trapezoidal tip on one end, and a triangular tip on the other end of said toothpick.

18. Toothpick as defined by claim 14, comprising a hook on each end of said toothpick.
